(19) United States
(12) Patent Application Publication
(10) Pub. No.: US 2018/0044249 A1
(43) Pub. Date: Feb. 15, 2018

(54) A METHOD OF FABRICATING A COMPOSITE MATERIAL PART BY SELF-PROPAGATING HIGH TEMPERATURE SYNTHESIS

(71) Applicants: SAFRAN CERAMICS, Le Haillan (FR); CENTRE NATIONAL DE LA RECHERCHE SCIENTIFIQUE, Paris (FR)

(72) Inventors: Brice TAILLET, Pizançon (FR); René PAILLER, Cestas (FR); Francis TEYSSANDIER, Pessac (FR); Eric PHILIPPE, Merignac (FR); Eric BOUILLON, Le Haillan (FR)

(21) Appl. No.: 15/326,881

(22) PCT Filed: Jul. 16, 2015
(86) PCT No.: PCT/FR2015/051943

§ 371 Date: Jan. 17, 2017

(30) Foreign Application Priority Data
Jul. 17, 2014 (FR) 1456895

(51) Int. Cl. C04B 35/80; C04B 35/65; F01D 25/00; C04B 35/628

(52) U.S. Cl. CPC C04B 35/80; C04B 35/62807; C04B 35/65; F01D 25/005; C04B 2235/5208; F05D 2300/6033

(57) ABSTRACT

A method of fabricating a part made of ceramic matrix composite material, the method includes fabricating the part by forming a ceramic matrix in the pores of a fiber structure, the ceramic matrix being formed by self propagating high temperature synthesis from a powder composition present in the pores of the fiber structure,

### BACKGROUND OF THE INVENTION

The invention relates to methods of fabricating parts out of ceramic matrix composite material and to parts that can be obtained by such methods.

It is known for fibers based on SiC coated with a pyrolytic carbon (PyC) type interphase to be protected from oxidation by means of a self-healing carbide matrix that also performs a mechanical load transferring function. The elastic limit of some of these materials can be relatively low, e.g. of the order of 60 megapascals (MPa). Beyond the elastic limit, a network of cracks can form in the matrix, which can lead to oxidation of the interphase and of the fibers. The self-healing nature of such materials, based on forming glasses by oxidizing carbide phases in the SiBC system, enables them to operate when they are damaged. Nevertheless, it can be difficult to synthesize carbide phases that can be oxidized at low temperature. Consequently, some such materials can present weakness at around 450° C. as a result of an unfavorable compromise between the rate of oxidation of the structural reinforcement (constituted by the fibers and the PyC interphase) and the rate of production of healing glasses. This can limit the performance of such materials and consequently the range of applications in which they can be used.

It is also known to fabricate ceramic matrix composite materials by performing melt-infiltration methods. Those methods rely on the principle of synthesizing a material having a high elastic limit and high thermal conductivity. The material may include an interphase of BN (or of silicon-doped BN) coated by a carbide phase of SiC type and/or an Si₃N₄ phase, these phases being made using a gas technique. The matrix is obtained by inserting ceramic and/or carbon fillers into a fiber preform and then impregnating with a molten alloy based on silicon, with the reaction taking place at a minimum temperature of 1420° C.

Such a method may require the use of fibers that are stable at high temperature, such as those supplied under the name “Hi-Nicalon S” by the Japanese supplier NGS. More precisely, a distinction can be drawn between the melt-infiltration method in which the inserted filler is SiC only, and the reactive melt-infiltration method in which a mixture of fillers comprising carbon is inserted, so as to lead to reactive impregnation with the silicon alloy as a result of the following reaction:

Si+C→SiC

Apart from the BN interphase, which can give rise to the B₂O₃ glass, the materials obtained by melt-infiltration may possess a self-healing system in a quantity that is not sufficient for operating in the cracked domain. In addition, such materials may also present an operating limit in the non-cracked domain for parts that are subjected to a complex combination of stresses over durations that are relatively long. Furthermore, the protection against oxidation imparted by the BN interphase can be ensured up to about 800° C. insofar as the rate of oxidation of BN remains low in this temperature range. Above this temperature, oxidation of BN into B₂O₃ can start to become significant, which can lead to a considerable decrease in the lifetime of the material.

Furthermore, the materials obtained by melt-infiltration can also be sensitive to the phenomenon of wet corrosion.

In addition, materials fabricated by performing melt-infiltration methods or reactive melt-infiltration methods may be limited by residual free silicon being present in the matrix. This can lead to a limit on the utilization temperature of the parts in question to around 1300° C.

It is also known to make ceramic matrices by chemical vapor infiltration (CVI). Such methods can have the drawback of being relatively lengthy and expensive to perform. Likewise, methods of densification by cycles of impregnating and pyrolyzing a polymer in order to form a matrix densifying a fiber structure can require a plurality of impregnation and pyrolysis cycles to be performed in order to obtain satisfactory porosity. Performing a plurality of cycles increases the duration and the cost of the method being implemented.

There therefore exists a need to have methods available for fabricating composite material parts that are quick and inexpensive to perform, and in particular in which any recourse to the chemical vapor infiltration method for forming the matrix is limited.

There also exists a need to obtain ceramic matrix composite materials in which the matrix presents a low content of residual free silicon, with the utilization temperature of such materials thus not being limited to 1300° C.

There also exists a need to obtain ceramic matrix composite materials presenting resistance to oxidation and to corrosion that are better than composite materials having a matrix based on SiC and on Si.

There also exists a need to have methods available for fabricating composite material parts that are compatible with using PyC and BN interphases and with all types of reinforcing fiber.

### OBJECT AND SUMMARY OF THE INVENTION

To this end, in a first aspect, the invention provides a method of fabricating a part made of ceramic matrix composite material, the method comprising the following step:

a) fabricating the part by forming a ceramic matrix in the pores of a fiber structure, the ceramic matrix being formed by self propagating high temperature synthesis from a powder composition present in the pores of the fiber structure.

The method of self propagating high temperature synthesis implemented in the context of the present invention is also known by its initials SHS.

So far as the inventors are aware, such a method has never been used for fabricating ceramic matrix composite materials having a fiber structure. In this method, the reaction performed is sufficiently exothermic for it to be self-sustaining so that there is self propagation of a reaction front along the fiber structure. Such a method is thus characterized by the self-sustaining propagation of a wave of high temperature along the fiber structure.

Implementing a method of self propagating high temperature synthesis advantageously makes it possible to obtain materials that are relatively pure, with reaction times that are particularly short. The method of the invention makes it possible to prepare a ceramic matrix composite material in a manner that is relatively simple, inexpensive, and fast. In particular, compared with a method of densification by cycles of impregnating and pyrolyzing a polymer, the method of self propagating high temperature synthesis can advantageously make it possible to obtain densification by means of a matrix in a single step, whereas densification by cycles of impregnating and pyrolyzing a polymer can require a plurality of impregnating and pyrolyzing cycles to be performed in order to obtain satisfactory porosity.

Self propagating high temperature synthesis can be initiated by local heating by concentrating energy, e.g. heating by microwaves, by laser, by a flame, by a high frequency (HF) generator, or by an igniter such as a resistance element, by placing the fiber structure in an oven, or indeed by an exothermic primary chemical reaction. A spark may also serve to initiate the self propagating high temperature synthesis. This type of method is relatively easy to perform since it does not require an excessive amount of energy to be supplied compared with conventional sintering methods.

The temperature at the reaction front can be relatively high. Nevertheless, the fiber structure is not damaged thereby, since the reaction front propagates quickly, thereby serving to limit the length of time during which the fibers, the interphase, or the protective barriers are exposed to high temperature. Thus, the method of self propagating high temperature synthesis does not affect the mechanical properties of the fiber structure being treated.

Advantageously, the matrix formed during step a) may have residual porosity less than or equal to 25%.

The term “residual porosity” specifies the following ratio: [volume occupied by all of the pores present in the part obtained after step a)] divided by [total volume of the part obtained after step a)].

Advantageously, the matrix formed during step a) does not present any macropores.

A pore defines an opening in the material, which opening has a length and a width. The term “macropore” designates a pore having an opening of length greater than or equal to 500 micrometers (μm) and a width greater than or equal to 100 μm.

Thus, in the matrix formed during step a), there remain only pores for which the maximum dimension lies in the range a few nanometers to a few hundreds of nanometers.

The residual porosity of the matrix can be measured by water porosimetry or impregnation.

It is thus advantageously possible to obtain ceramic matrix composite materials in which the matrix presents residual porosity that is limited, and in particular more limited than in the matrices conventionally obtained by performing a chemical vapor infiltration method.

In an implementation, a chemical reaction between the powder composition and the gaseous phase can take place during a method of self propagating high temperature synthesis. Under such circumstances, the gaseous phase may comprise the element N, e.g. may comprise N₂. In a variant, during the method of self propagating high temperature synthesis, a chemical reaction may take place solely between the constituents of the powder composition. Examples showing these two types of method of self propagating high temperature synthesis are described in detail below.

In an implementation, throughout part or all of step a), the fiber structure may be present in a volume that is maintained at a temperature less than or equal to 2000° C., e.g. less than or equal to 1500° C., preferably less than the degradation temperature of the fibers used.

In an implementation, the powder composition may be inserted into the pores of the fiber structure before step a).

In a variant, the powder composition may be formed before step a) directly in the pores of the fiber structure by transforming a precursor composition previously inserted into the pores of the fiber structure.

The transformation of the precursor composition is advantageously a chemical transformation.

The precursor composition may be in the form of a powder. In a variant, the precursor composition may comprise a polymer, the polymer being pyrolyzed prior to step a) in order to form some or all of the powder composition in the pores of the fiber structure. The polymer may be a filled polymer. The polymer may be an optionally-filled polysiloxane or polycarbosilane.

Preferably, the grains of the powder composition may have a median diameter less than or equal to 1.5 μm.

Unless specified to the contrary, the term “median diameter” designates the dimension given by the half-population statistical grain size distribution, known as D50.

Such grain diameters for the powders used make it possible advantageously to further improve both the filling of the pores of the fiber structure and also the reactivity of the powders during step a).

The median diameter of the grains of the powder composition may typically lie in the range a few nanometers to a few micrometers, preferably 0.5 μm to 1.5 μm. By way of example, the grains of the powder composition may have a median diameter lying in the range 200 nanometers (nm) to 1 μm, e.g. in the range 200 nm to 800 nm.

In an implementation, the fiber structure may comprise carbon fibers and/or ceramic fibers.

The ceramic fibers may comprise nitride type fibers, carbide type fibers, e.g. SiC fibers, oxide type fibers, and mixtures of such fibers.

In an implementation, the fibers of the fiber structure may be coated with an interphase coating.

The interphase coating may comprise, and may in particular consist of: PyC, BC, or BN.

Advantageously, prior to step a), a preliminary step b) may be performed of densifying the fiber structure by a method other than the method of self propagating high temperature synthesis.

The preliminary densification can make it possible to obtain a fiber structure that, prior to step a), presents porosity lying in the range 20% to 80%, and preferably in the range 35% to 55%.

The term “porosity” should be understood as designating the following ratio: [volume occupied by all of the pores in the fiber structure] divided by [total volume of the fiber structure].

Alternatively or in combination, an additional step c) of densifying the part may be performed after step a).

The preliminary and/or complementary densification may be performed by chemical vapor infiltration and/or by cycles of impregnating and pyrolyzing a polymer.

It may be advantageous to perform preliminary densification prior to step a), preferably by chemical vapor infiltration. Such preliminary densification serves to form a consolidation coating bonding together the fibers and enabling the consolidated structure to conserve its shape on its own and without assistance from support tooling. Performing such preliminary densification prior to step a) also serves to further improve the ability of the fibers to withstand the method of self propagating high temperature synthesis.

In an implementation, the following steps may be performed prior to step a):
inserting at least a first powder into the pores of the fiber structure, e.g. a first mixture of powders; then
inserting at least a second powder different from the first into the pores of the fiber structure, e.g. a second mixture of powders different from the first mixture of powders;

it being possible, after step a), to obtain a ceramic matrix of composition that varies on going towards the outside surface of the part.

An implementation advantageously makes it possible to create composition gradients on the surface, in particular in order to define. external protection, e.g. a thermal and/or environmental barrier. Under such circumstances, after step a), a part is obtained in which a thermal and/or environmental barrier defines some or all of the outside surface of the part.

The first powder or the first mixture of powders may participate in the self propagating high temperature synthesis, or in a variant it may constitute a composition that is a precursor for the powder composition that participates in the self propagating high temperature synthesis.

The constituent(s) of the second powder or the second mixture of powders may optionally participate in a chemical reaction during step a). By way of example, the second powder or the second mixture of powders may comprise a rare earth silicate, e.g. comprising yttrium.

In an implementation, the method may also comprise a step of forming an environmental and/or thermal barrier, the environmental and/or thermal barrier being present after step a) over all or some of an outside surface of the part.

In an implementation, the environmental and/or thermal barrier may be formed after implementing step a). Under such circumstances, the environmental and/or thermal barrier forms a coating covering all or some of the outside surface of the part. In a variant, the environmental and/or thermal barrier may be formed during step a). Under such circumstances, the environmental and/or thermal barrier defines all or some of the outside surface of the part. Under such circumstances, the environmental and/or thermal barrier results from the presence, prior to step a), of a second powder or a second mixture of powders in the pores of the fiber structure.

Preferably, the matrix formed during step a) may comprise a majority by weight of Si₂N₂O formed by self propagating high temperature synthesis by chemical reaction between a silicon powder, a silica powder, and a gaseous phase comprising the element N.

The term “the matrix comprises a majority by weight of X” should be understood as meaning that the compound X is present in the matrix at a weight content greater than 50%, preferably greater than or equal to 60%, preferably greater than or equal to 70%.

It is advantageous to form a matrix based on Si₂N₂O since this material presents excellent ability to withstand oxidation (better than that of SiC) and it gives the resulting part very good ability to withstand wet corrosion. Si₂N₂O also presents good temperature stability, low density, and good mechanical properties.

Known methods of forming Si₂N₂O may implement processing temperatures higher than 1700° C. and high pressures, which operating conditions are incompatible with processing a fiber preform. Specifically, synthesizing Si₂N₂O by hot isostatic pressing (HIP), for example, is not compatible with using SiC fibers of the Hi-Nicalon S type. The reaction temperature may reach 1950° C. In addition, reaction time in a hot isostatic pressing method can be significantly longer than the reaction time in a method of self propagating high temperature synthesis.

Thus, one of the advantages of the invention associated with using a method of self propagating high temperature synthesis is that it enables Si₂N₂O to be formed quickly without damaging the fiber structure that is being treated.

The method of the invention advantageously makes it possible to obtain a ceramic matrix composite material part that can be used up to at least 1450° C., and possibly even up to 1800° C., unlike parts in which the matrix is formed by melt infiltration or by densification using cycles of impregnating and pyrolyzing a polymer, for which use can be limited to temperatures lower than 1300° C. because of the significant presence of residual free silicon in the matrix.

Thus, advantageously, the matrix formed during step a) may present a content by weight of residual free silicon that is less than or equal to 5%.

The contents by weight of the various constituents present in the matrix, e.g. Si₂N₂O, residual free silicon, and the compounds α-Si₃N₄ and β-Si₃N₄, can be quantified by X-ray diffraction (XRD). XRD analysis is performed on a sample of the matrix taken in the thickness and at the center of the part obtained by the method of the invention.

Forming a Si₂N₂O matrix by a self propagating high temperature synthesis reaction is particularly advantageously compared with forming Si₂N₂O matrices using methods of densification by means of cycles of polymer impregnation and pyrolysis (PIP). Specifically, as a result of performing a plurality of successive cycles, Si₂N₂O matrices formed by such methods may present purity and/or uniformity that are not sufficient. The formation of Si₂N₂O by methods of densification by cycles of polymer impregnation and pyrolysis may also lead to obtaining Si₂N₂O that is amorphous, whereas the method of self propagating high temperature synthesis makes it possible to obtain a significant quantity of Si₂N₂O that is crystalline. The formation of Si₂N₂O by a self propagating high temperature synthesis reaction can thus advantageously make it possible to avoid any need to have recourse to additional heat treatment for transforming amorphous Si₂N₂O into crystalline Si₂N₂O, which heat treatment can lead to degradation of the fibers.

Nevertheless, after step a), it is possible to perform heat treatment in order to increase the crystallization of Si₂N₂O and/or to achieve a growth in the size of the resulting grains of Si₂N₂O.

Advantageously, the matrix obtained after performing step a) may comprise a phase of crystalline Si₂N₂O at a content by weight that is greater than or equal to 70%.

It is possible to form Si₂N₂O by performing the following chemical reaction during step a):

3Si₍ₛ₎+SiO₂₍ₛ₎+2N_{2(g)}→2Si₂N₂O₍ₛ₎

In an implementation, the gaseous phase may also comprise O₂ and/or N₂O.

Introducing a partial pressure of O₂ and/or of N₂O in the gaseous phase makes it possible advantageously to increase the proportion of Si₂N₂O that is formed during step a) and to reduce the proportion of other compounds that may be formed during step a), such as Si₃N₄.

Advantageously, a silicon powder may be inserted into the pores of the fiber structure prior to step a), and treatment for partial oxidation of the silicon powder may be implemented prior to step a), this partial oxidation treatment serving to convert some or all of the silicon powder into silica. This implementation corresponds to introducing a precursor composition comprising silicon into the pores of the fiber structure prior to step a). In particular, the silicon may be present in the precursor composition that is introduced at a content by weight lying in the range 58% to 100%.

Such oxidation pretreatment serves advantageously to reduce the quantity of Si₃N₄ that is formed during step a). Specifically, a silica layer forms around the silicon particles during the oxidation pretreatment. Under nitrogen pressure, the silicon that is protected in this way nitrides less easily, so the formation of Si₂N₂O is enhanced relative to the formation of Si₃N₄.

Compared to the situation in which no oxidation pretreatment is performed, this implementation in which silica is formed in situ as the result of the oxidation pretreatment can also serve to further reduce the residual porosity of the part that is obtained after performing step a).

In an implementation, the ratio [quantity of material of the silicon powder prior to initiating self propagating high temperature synthesis] divided by [quantity of material of the silica powder prior to initiating self propagating high temperature synthesis] may be greater than or equal to 3, e.g. lying in the range 3 to 3.5.

In particular, the ratio [quantity of material of the silicon powder prior to initiating self propagating high temperature synthesis] divided by [quantity of material of the silica powder prior to initiating self propagating high temperature synthesis] may be substantially equal to 3. In such an Si—SiO₂ mixture, the content by weight of silicon is 58%.

When a gaseous phase is used during the method of self propagating high temperature synthesis, the pressure of the gas phase during all or some of step a) may lie in the range 10 bar to 50 bar, and preferably in the range 20 bar to 30 bar.

Advantageously, a stage of raising temperature at a mean rate of temperature rise greater than or equal to 90° C./minute (min) is performed prior to step a).

Such values for the rate of temperature rise serve advantageously to enhance the formation of Si₂N₂O relative to the formation of Si₃N₄.

Preferably, a powder comprising boron may be present in the pores of the fiber structure prior to step a), and during step a) the powder comprising boron may form a BN phase by a nitriding reaction with the gaseous phase.

Adding boron to the Si/SiO₂ mixture serves to enhance densification of the composite material. Specifically, nitriding the boron (forming BN) leads to its volume increasing by 140%. Under such circumstances, the matrix comprises Si₂N₂O, BN, and optionally Si₃N₄.

In particular, the powder comprising boron may be boron powder.

The method of the invention is not limited to forming a matrix based on Si₂N₂O, as described in detail below.

Preferably, the matrix formed in step a) may comprise a majority by weight of phases of TiN and of TiB₂, these compounds being formed by self propagating high temperature synthesis by chemical reaction between a powder comprising titanium, a powder comprising boron, and a gaseous phase comprising the element N.

The term “matrix comprising a majority by weight of phases of . . . and of . . . ” should be understood meaning that the sum of the contents by weight of said phases in the matrix is greater than 50%, preferably greater than or equal to 60%, preferably greater than or equal to 70%.

Titanium nitride (TiN) is very hard, possesses good thermal conductivity, and has a high melting point (3200° C.). Direct nitriding of titanium under pressure (20 bar-100 bar) can generate a material that is relatively dense but cracked, as a result of the thermal shock caused by the exothermic nature of the reaction (maximum combustion temperature about 3000° C. at a pressure of 40 bar of dinitrogen). In order to reduce the exothermic nature of the reaction and thus avoid cracking the material during the preparation stage, a powder comprising boron, e.g. a powder of boron nitride (BN) may be added to the titanium. Titanium diboride (TiB₂) is then formed in addition to TiN. Titanium diboride also presents a high melting point (3225° C.), good resistance to oxidation, and very great hardness.

In particular, TiN and TiB₂ may be formed by self propagating high temperature synthesis as a result of a chemical reaction between titanium powder, BN powder, and a gaseous phase comprising the element N, e.g. a gaseous phase comprising N₂.

Preferably, the matrix formed during step a) may comprise a majority by weight of phases of TiC and of SiC, these compounds being formed by self propagating high temperature synthesis by a chemical reaction between a powder comprising titanium, a powder comprising silicon, and a powder comprising carbon.

In particular, these compounds may be formed by self propagating high temperature synthesis by chemical reaction between titanium powder, silicon powder, and carbon powder.

Preferably, the matrix formed during step a) may comprise a majority by weight of AlN formed by self propagating high temperature synthesis by a chemical reaction between a powder comprising aluminum and a gaseous phase comprising the element N.

Aluminum nitride presents numerous advantages as a matrix material, such as a high melting point (2300° C.), good thermal conductivity, a low coefficient of thermal expansion, and very good resistance to oxidizing.

In particular, AlN may be formed by self propagating high temperature synthesis by chemical reaction between aluminum. powder and a gaseous phase comprising the element N, e.g. a gaseous phase comprising N₂.

It may be advantageous to add carbon powder to the aluminum powder.

Adding carbon powder makes it possible advantageously to increase the yield of nitriding aluminum, by reacting with the protective alumina layer present on the particles of aluminum (chemical reduction).

Preferably, the matrix formed during step a) may comprise a majority by weight of phases of BN and of Ti—C—N, these compounds being formed by self propagating high temperature synthesis by chemical reaction between a powder comprising titanium, a powder comprising boron and carbon, and a gaseous phase comprising the element N.

Boron nitride (BN) is a highly covalent ceramic that possesses excellent ability to withstand corrosion and oxidation.

In particular, these compounds may be formed by self propagating high temperature synthesis by chemical reaction between titanium powder, B₄C powder, and a gaseous phase comprising the element N, e.g. a gaseous phase comprising N₂.

The matrix formed during step a) may preferably comprise a majority by weight of phases of Al₂O₃ and of SiC, these compounds being formed by self propagating high temperature synthesis by chemical reaction between a powder comprising silicon and oxygen, a powder comprising aluminum, and a particular comprising carbon.

In particular, these compounds may be formed by self propagating high temperature synthesis by chemical reaction between silica powder, aluminum powder, and carbon powder.

The matrix formed during step a) may preferably comprise a majority by weight of a SiAlON type compound formed by self propagating high temperature synthesis by chemical reaction between silicon powder, silica powder, a powder comprising aluminum, and a gaseous phase comprising the element N.

SiAlONs are ceramics possessing excellent resistance to oxidation, and good mechanical properties.

In particular, a β-Si₅AlON₇ phase may be formed by self propagating high temperature synthesis by chemical reaction between silicon powder, silica powder, aluminum powder, and a gaseous phase comprising the element N, e.g. a gaseous phase comprising N₂.

The present invention also provides a part made of ceramic matrix composite material, the part comprising:
a reinforcing fiber structure; and
a ceramic matrix comprising a majority by weight of Si₂N₂O present in the pores of the fiber structure, the matrix presenting a content by weight of residual free silicon that is less than or equal to 5%.

Such a part may be obtained by the method as described above.

Advantageously, the matrix may have residual porosity less than or equal to 25%.

Advantageously, the matrix may comprise crystalline Si₂N₂O at a content by weight greater than or equal to 70%.

The present invention also provides a turbine engine including a part as defined above.

The present invention also provides a method of fabricating a turbine engine including a step of assembling a part as described above or a part obtained by performing a method as described above with one or more other elements.

### BRIEF DESCRIPTION OF THE DRAWINGS

Other characteristics and advantages of the invention appear from the following description of particular implementations of the invention, given as nonlimiting examples, and with reference to the accompanying drawings, in which:

FIG. 1 is a flowchart of an example of a method of the invention;

FIGS. 2 and 3 are flowcharts of variant methods of the invention;

FIGS. 4 to 6 are more detailed flowcharts of examples of methods of the invention;

FIGS. 7 and 8 are photographs obtained by a scanning electron microscope of a composite material part formed by performing an implementation of the method of the invention; and

FIG. 9 is a photograph obtained by a scanning electron microscope of a part made of composite material formed by performing another implementation of the method of the invention.

### DETAILED DESCRIPTION OF IMPLEMENTATIONS

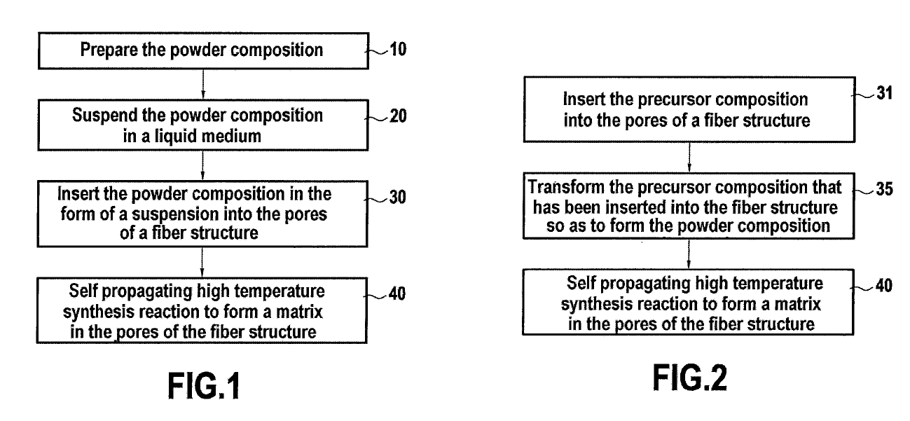

FIG. 1 shows a succession of steps of a method of the invention. A powder composition is initially prepared (step 10). The powder composition may comprise a mixture of an Si powder and an SiO₂ powder when it is desired to obtain a matrix based on Si₂N₂O.

Thereafter, the mixture prepared in step 10 is put into suspension in a liquid medium, e.g. in water (step 20). When it is desired to obtain a matrix based on Si₂N₂O, the silicon and silica powders may be present in the liquid medium at a volume content (sum of the volume content of the silicon powder plus the volume content of the silica powder) that is greater than or equal to 15%, e.g. lying in the range 15% to 25%.

The powder composition in suspension in the liquid medium is then introduced into the pores of a fiber structure, e.g. by a submicron powder aspiration (SPA) type method (step 30).

Synthesis is then performed by self-sustaining reaction at high temperature, enabling a matrix to be formed in the pores of the fiber structure (step 40). Throughout all or some of step a), the fiber structure may be present in a volume that is maintained at a temperature less than or equal to 1500° C., e.g. less than or equal to 1450° C.

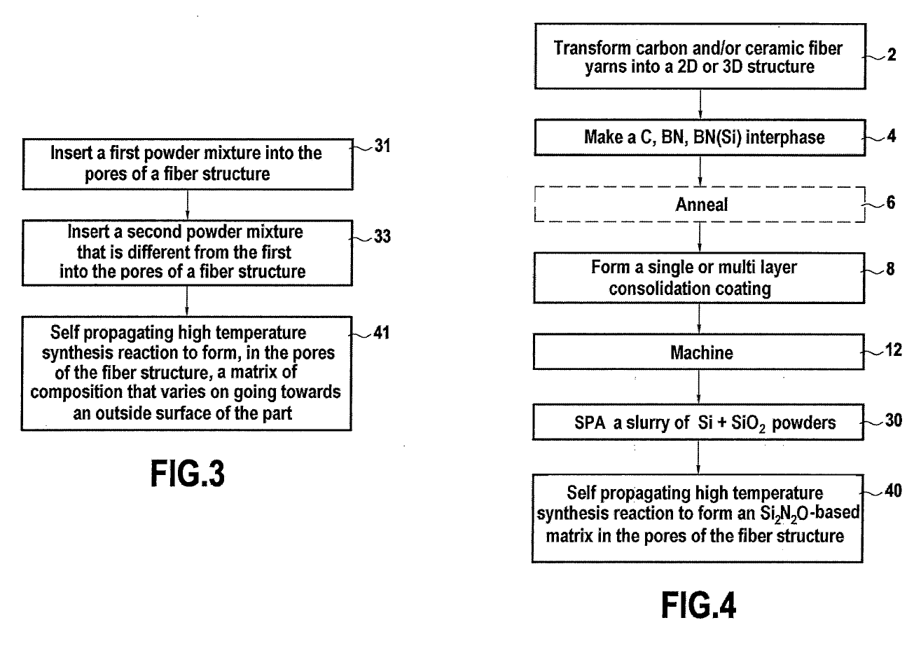

FIG. 2 is a flowchart showing a variant implementation of a method of the invention.

In a first step 31, a precursor composition is introduced into the pores of a fiber structure. By way of example, the precursor composition may comprise a polymer that is to be pyrolyzed in order to form the powder composition. In a variant, the precursor composition is in the form of a powder, e.g. a silicon powder when it is desired to obtain a matrix based on Si₂N₂O.

Thereafter, the precursor composition is transformed into a powder composition (step 35). For example, when the precursor composition comprises a silicon powder, it is possible to perform oxidation treatment on the silicon powder in order to obtain a powder composition comprising silica powder and silicon powder so as to form a matrix based on Si₂N₂O by a self propagating high temperature synthesis reaction. By way of example, the heat treatment performed for transforming a portion of the silicon powder into silica may include subjecting the silicon powder to a temperature of 900° C. for 1 h in air. In a variant, when the precursor composition includes a polymer, step 35 may include heat treatment for pyrolyzing said polymer in order to obtain the powder composition.

Synthesis by a self propagating high temperature reaction enables a matrix to be formed in the pores of the fiber structure (step 40).

When it is desired to obtain a matrix of Si₂N₂O, the fact of using a precursor composition in the form of a silicon powder and of transforming it in part into silica directly in the fiber structure makes it possible to obtain better densification. This transformation makes it possible to obtain better filling of the pores of the fiber structure after partial oxidation of the silicon powder. For example, if a silicon powder is inserted by SPA so as to fill the pores of the fiber structure by 55%, it is possible, after oxidation, to obtain filling of the pores of the fiber structure of 68%. By forming silica in situ, it is thus possible after step a) to obtain a matrix presenting particularly little residual porosity.

FIG. 3 is a flowchart showing a variant implementation of a method of the invention. During step 32, a first powder mixture is inserted into the pores of the fiber structure. Thereafter, a second powder mixture, different from the first powder mixture, is inserted into the fiber structure (step 33). Because of the prior introduction of the first powder mixture, the quantity of the second powder mixture present in the fiber structure reduces with increasing depth into the fiber structure. As a result of this variation, it becomes possible after step 41 to obtain a ceramic matrix of composition that varies on going towards an outside surface of the part. Under such circumstances, after step a), it is advantageously possible to form an environmental and/or thermal barrier defining all or some of the outside surface of the part. Consequently, such a variant method presents the advantage of making it possible in a single step both to densify the fiber structure and to form an environmental and/or thermal barrier.

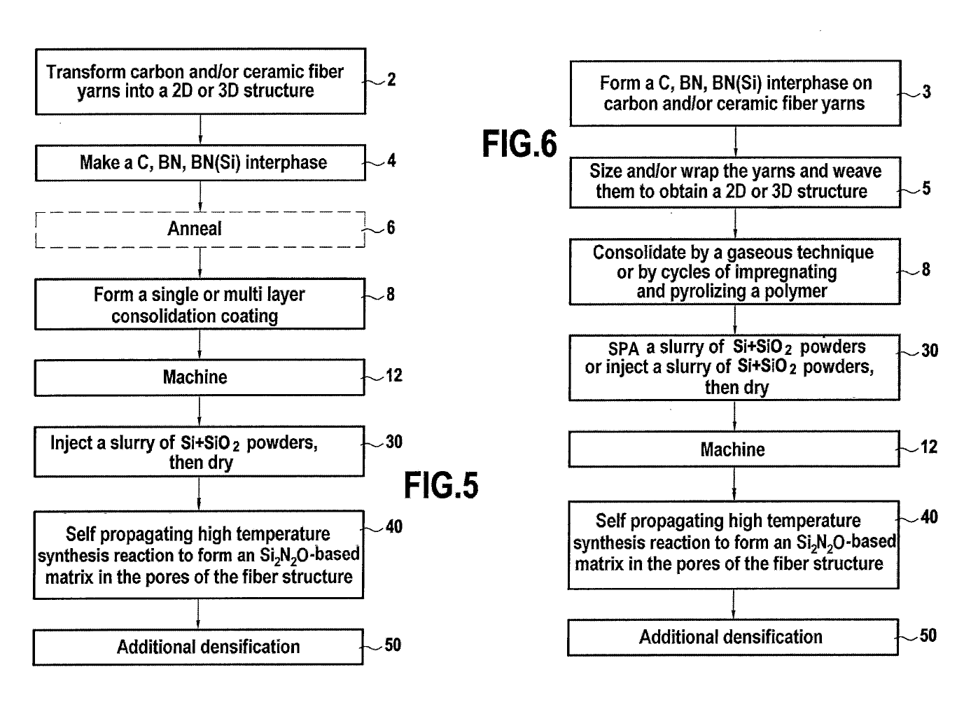

With reference to FIGS. 4 to 6, there follows a description of a few examples of successions of steps that can be performed in the context of the invention when it is desired to obtain a matrix based on Si₂N₂O. For reasons of concision, these figures relate only to forming a matrix based on Si₂N₂O, however, and as explained above, it should naturally be understood that the invention is not limited to forming matrices based on Si₂N₂O.

FIG. 4 shows the succession of steps of an example method of the invention. During step 2, a plurality of yarns are transformed into a fiber structure, e.g. a 2D or a 3D structure. This may be done using any method known to the person skilled in the art.

The yarns 1 that are used comprise a plurality of ceramic and/or carbon fibers. By way of example, the ceramic fibers are SiC fibers. By way of example, suitable SiC fibers are supplied under the names “Nicalon”, “Hi-Nicalon” or “Hi-Nicalon-S” by the Japanese supplier NGS, or under the name “Tyranno SA3” by the supplier UBE. By way of example, suitable carbon fibers are supplied under the name “Torayca” by the supplier Toray.

Thereafter, an interphase is made on the yarns (step 4). The interface serves advantageously to increase the mechanical strength of the ceramic matrix composite material, in particular by deflecting any cracks in the matrix so that they do not affect the integrity of the fibers. In a variant, the fibers are not coated in an interphase. Thereafter, it is then possible to perform annealing treatment (step 6, which is optional in the example method being described).

During step 8, a consolidation coating is formed on the fibers. For this purpose, the fiber structure may be placed in a shaper and the consolidation coating may be formed by chemical vapor infiltration. By way of example, the consolidation coating comprises a carbide, with the consolidation coating being SiC, B₄C, and/or SiBC, for example. The consolidation coating may constitute a chemical and/or thermal barrier serving to protect the fibers and the interphase (if there is one) from possible degradation.

It is then possible to perform a step of machining the fiber structure (step 12). After this machining step, the powder composition present in the form of a suspension in a liquid medium is inserted into the fiber structure by a sub-micrometer powder suction method (step 30). Thereafter, self propagating high temperature synthesis is performed in order to perform the matrix based on Si₂N₂O (step 40).

As mentioned above, Si₂N₂O presents numerous advantages. In particular, this material presents greater resistance to oxidation than does SiC (oxidation start temperature: 1600° C. under dry air). Furthermore, the mechanical properties of the Si₂N₂O material are compatible with it being associated in the part being made both with the SiC fibers (e.g. of the “Hi-Nicalon S” type) and also with an Si₃N₄ phase (see table 1 below).

| | Si₂N₂O | Si₃N₄ | SiC |
|---|---|---|---|
| Young's modulus | 230 | 320 | 400 |
| (GPa) | | | |
| Specific gravity | 2.81 | 3.27 | 3.20 |
| Expansion | 3.5 × 10⁻⁶ | 3.6 × 10⁻⁶ | 5 × 10⁻⁶ |
| coefficient (K⁻¹) | | | |

When the matrix formed during step a) has a majority phase of Si₂N₂O, it is possible to form compounds other than Si₂N₂O, such as Si₃N₄, in the matrix. The content by weight of Si₃N₄ in the matrix formed during step a) is less than 50%, preferably less than or equal to 5%.

There follow a few examples of structures that may be formed by a method of the invention:
SiC/Interphase, PyC/SiC consolidation, or Si₃N₄/matrix fibers including Si₂N₂O formed by self propagating high temperature synthesis from a mixture of Si and SiO₂ powders under nitrogen pressure;
SiC/Interphase, PyC/SiC consolidation, or Si₃N₄/matrix fibers including Si₂N₂O and a compound of formula SiₓB_{y} formed by self propagating high temperature synthesis from a mixture of Si, SiO₂, and B powders under nitrogen. pressure;
SiC/Interphase, PyC/SiC consolidation, or Si₃N₄/matrix fibers including Si₂N₂O and SiAlON formed by self propagating high temperature synthesis from a mixture of Si, SiO₂, and Al powders under nitrogen pressure.

FIG. 5 shows a variant method of the invention. The sequence of steps in FIG. 5 differs from that in FIG. 4 by the method used for introducing the powder composition into the fiber structure and by the fact that post-treatment is performed after step a).

In the example of FIG. 5, the powder composition in the form of an aqueous suspension is inserted into the fiber matrix by injection, with heat treatment then being performed to evaporate the water. The injection and the heat treatment that are performed may be of the same type as those implemented in methods of molding by injecting resin (methods known as resin transfer molding or “RTM”). It is possible to use other methods known to the person skilled in the art to insert the powder composition into the fiber structure, and thus, by way of example, it is possible to insert the powder composition into the fiber structure by electrophoresis.

Once the self propagating high temperature synthesis has been performed, an additional densification step c) may be performed, e.g. by cycles of impregnating and pyrolyzing a polymer in order to fill in the residual porosity of the resulting matrix (step 50). In a variant, during step 50, an additional step of spark plasma sintering (SPS) densification may be performed in order to increase the final density of the part.

FIG. 6 shows the succession of steps in another example method of the invention. In this example, an interphase is initially formed on the yarns prior to forming the fiber structure (step 3). Thereafter, the yarns are subjected to sizing and/or wrapping treatment followed by a textile operation such as weaving in order to obtain the fiber structure (step 5). The powder composition is inserted into the fiber structure, a matrix is formed by self propagating high temperature synthesis, and then additional densification is performed, as explained above.

### EXAMPLES

### Example 1

### Forming a Matrix Having an Si₂N₂O Phase From Silicon and Silica Powders

The sequence of the various steps of a method of the invention is described below.

Commercially-available powders of silicon and of silica were initially subjected to attrition grinding. Silica and silicon powders made available by the supplier Sigma-Aldrich were used. Before grinding, the silica powder used presented grains having a median diameter (D50) equal to 2.1 μm, and the silicon powder used presented grains having a median diameter (D50) equal to 11 μm.

Grinding served to adjust the grain sizes of the silica and silicon powders. After grinding, the median diameter (D50) of the grains of silica powder was about 600 nm and the median diameter (D50) of the grains of silicon powder was about 400 nm.

The silicon powder was then subjected to heat treatment at 600° C. for 6 h in air in order to improve its wettability.

A stable aqueous suspension filled with the powders up to 20% by volume was then prepared. The suspension presented a pH lying in the range 9 to 9.5 and it was stabilized by adding tetramethylammonium hydroxide (TMAH). The Si/SiO₂ molar ratio in the suspension was about 3.

A fiber preform was impregnated by a submicron powder aspiration (SPA) method under a pressure of 4 bars and with application of a vacuum for 2 h. The fiber preform used had a plurality of SiC fibers sold under the name “Hi-Nicalon-S”, coated with a PyC interface having a thickness of 100 nm and an SiC consolidation coating having a thickness of 1 μm. The fiber preform used presented initial porosity of 54% (results obtained by three different measurements giving similar values: helium pycnometry, water impregnation, mercury porosimetry).

Once the powders had been inserted in the fiber preform, the following heat treatment under pressure was performed to implement self propagating high temperature synthesis (“SHS” method):
raise temperature at 250° C./min up to a temperature of 1400° C. by Joule effect heating;
pause for 30 min at 1400° C. under a pressure of 20 bars of nitrogen; and
controlled cooling down to ambient temperature.

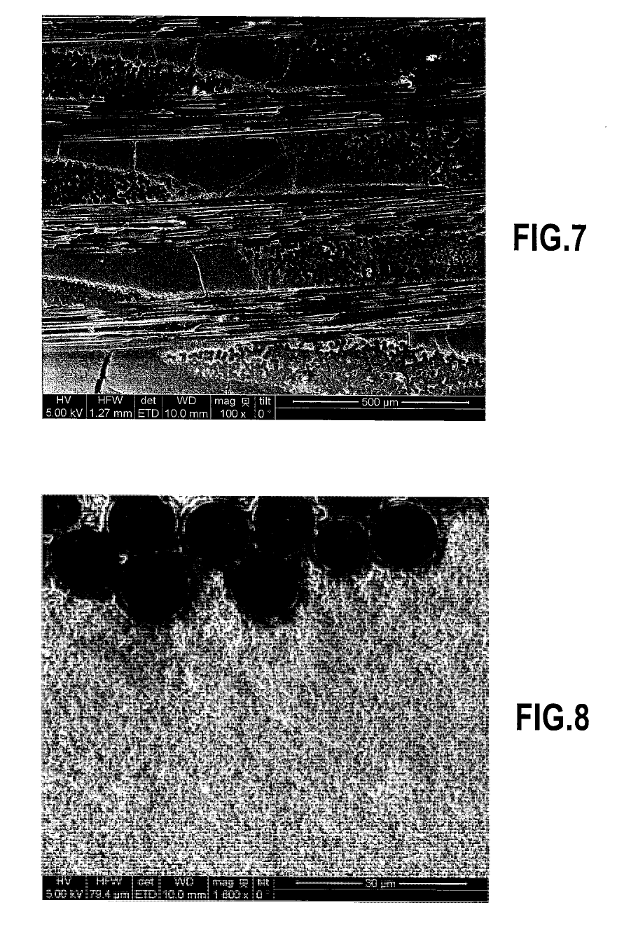

After performing such a protocol, the results given in FIGS. 7 and 8 were obtained. The matrix achieved effective and uniform filling of the pores in the fiber structure. The fibers, the interface, and the consolidation coating were not damaged by the self propagating high temperature synthesis.

After XRD analysis, the following results were obtained for the composition of the matrix: 75% by weight of crystalline Si₂N₂O, presence of phases of α-Si₃N₄ and β-Si₃N₄, and concentration of residual free silicon in the matrix less than or equal to 5% by weight. The residual porosity of the resulting material was about 23% (measured by immersion in water).

The step of impregnating the preform by SPA followed by self propagating high temperature synthesis made it possible to fill in about 55% of the initial porosity.

### Example 2

### Forming a Matrix Comprising an Si₂N₂O Phase Involving Partial Oxidation Pre-Treatment Prior to Step a)

The sequence of the various steps of another example method of the invention is described below:

1/ Grinding SiO₂ powder under water and Si powder under isopropanol/ethanol, The powders presented a median diameter lying in the range 0.5 μm to 1 μm.

2/ Subjecting the silicon powder to heat treatment at 600° C. for 6 h under air.

3/ obtaining a powder mixture constituted by 73% by weight of Si and 27% by weight of SiO₂, giving an Si/SiO₂ molar ratio of 5.77.

4/ Putting the powders into suspension in water, the suspension being stabilized at a pH of 9 with TMAH, and presenting a dry matter content of 20% by volume.

5/ Impregnating by SPA (4 bar to vacuum for 2 h) into a fiber structure made up of ceramic fibers coated with an interphase of pyrocarbon and SiC consolidation.

6/ Drying the material at 100° C. overnight.

7/ Oxidation heat treatment of the silicon powder after the SPA step: 1 h at 900° C. under air.

8/ Heat treatment by self propagating high temperature synthesis: rise to 1450° C. at a rate of 200° C./min under 20 bar of dinitrogen. Pause at temperature for 10 min. Controlled cooling down to ambient temperature.

The matrix was made up of 86% by weight of crystalline Si₂N₂O, 12% by weight of Si₃N₄, and 2% by weight of Si.

The residual porosity was about 17%.

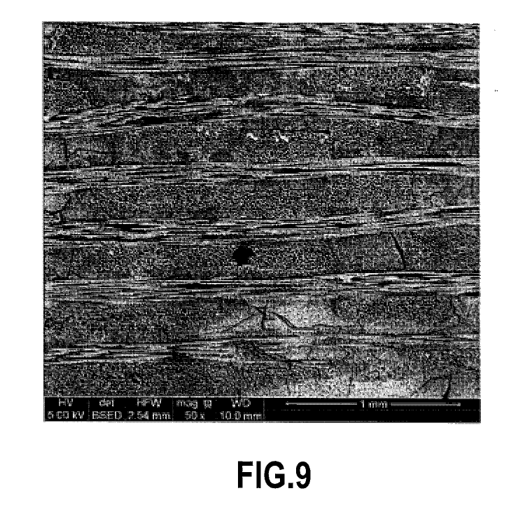

The matrix was uniform and dense (see FIG. 9) and the residual porosity of the material obtained was even less than that of material obtained in example 1.

### Example 3

### Forming a Matrix Having an Si₂N₂O Phase From Silicon, Silica, and Boron Powders

The sequence of the various steps of another example method of the invention is described below:

1/ Separate grinding of the Si and B powders under isopropanol/ethanol, and of the SiO₂ in distilled water.

2/ Subjecting the silicon powder to heat treatment at 600° C. in air in order to facilitate putting it into suspension.

3/ Mixing together the powders having the following composition by weight: Si/SiO₂=1.4+10% B.

4/ Putting into aqueous suspension (dry matter content lying in the range 15% to 20% by volume). pH was controlled by adding a strong base, TMAH.

5/ Impregnating by SPA in a fiber preform.

6/ Drying.

7/ Heat treatment by the method of self propagating high temperature synthesis: rise to 1450° C. at a rate of 200° C./min under 20 bar or 30 bar of dinitrogen. Pause at temperature for 10 min. Controlled cooling down to ambient temperature.

### Example 4

### Forming a Matrix Comprising Phases of TiN and TiB₂

The sequence of the various steps of another example method of the invention is described below:

1/ Mixing commercially-available powders of Ti and BN with the following composition: BN/Ti=1 (molar ratio) i.e. BN/Ti=0.52 (weight ratio). The grains of the powders used had a median diameter lying in the range 0.5 μm to 1 μm.

2/ Putting the powders into suspension in ethanol and adding 2 milligrams per square meter (mg/m²) of polyethylene imine (PEI) as steric dispersant. The quantity of dry matter in suspension lay in range 15% to 20% by volume.

3/ Impregnating by SPA (4 bar to vacuum) into a fiber structure made up of ceramic fibers coated with an interphase of pyrocarbon and SiC consolidation.

4/ Drying.

5/ Heat treatment by the method of self propagating high temperature synthesis: rise to 950° C. at a rate of 200° C./min under 40 bar of dinitrogen. Controlled cooling down to ambient temperature.

BN, Ti and N₂ react within the pores of the fiber structure in order to obtain a matrix based on TiB₂ and on TiN, with the following reaction:

yTi₍ₛ₎+xBN₍ₛ₎+0.5(y−1.5x)N_{2(g)}→0.5xTiB₂₍ₛ₎+(y−0.5x)TiN₍ₛ₎

This method obtained a matrix comprising 55% by weight of TiB₂ and 35% by weight of TiN. The maximum combustion temperature remained less than 1500° C.

### Example 5

### Forming a Matrix Comprising Phases of TiC and SiC

The sequence of the various steps of another example method of the invention is described below:

1/ Grinding the silicon powder in isopropanol/ethanol. The powder had a median diameter lying in the range 0.5 μm to 1 μm.

2/ Mixing the powders in order to obtain a mixture constituted by 48% by weight of Ti (commercially-available titanium powder), 28% by weight of Si, and 24% by weight of C (0.8 μm Luvomax).

3/ Putting the powders into suspension in ethanol and adding 2 mg/m² of PEI as steric dispersant. The quantity of dry matter in suspension lay in range 15% to 20% by volume.

4/ Impregnating by SPA (4 bar to vacuum) into a fiber structure made up of ceramic fibers coated with an interphase of pyrocarbon and SiC consolidation.

5/ Heat treatment by the method of self propagating high temperature synthesis: initiating the reaction at 650° C. under an inert atmosphere. Controlled cooling down to ambient temperature.

The Ti, Si, and C powders react inside the pores of the fiber structure in order to obtain a matrix made up of TiC and SiC, with the following reaction:

xTi₍ₛ₎+(1−x)Si₍ₛ₎+C₍ₛ₎→xTiC₍ₛ₎+(1−x)SiC₍ₛ₎

The reaction that leads to TiC being synthesized by self propagating high temperature synthesis is extremely exothermic and fast. In contrast, although the reaction between Si and C for forming SiC is also exothermic, it is not sufficiently exothermic to be self propagating.

Thus, a material made up of TiC and SiC can be synthesized by coupling a powerful exothermic reaction (Ti+C) with one that is less so (Si+C). It should be observed that under such circumstances, the reaction does not require the participation of a gaseous phase in order to propagate.

### Example 6

### Forming a Matrix Comprising a Phase of AlN

The sequence of the various steps of another example method of the invention is described below:

1/ Mixing together commercially-available powders having a weight ratio of Al/AlN=1 or of Al/Si₃N₄=1, with NH₄F being present in the mixture at 3% by weight and C being present in the mixture at 3% by weight.

2/ Putting the powders into suspension in ethanol and adding 2 mg/m² of PEI as steric dispersant. The quantity of dry matter in suspension lay in range 15% to 20% by volume.

3/ Impregnating by SPA (4 bar to vacuum) into a fiber structure made up of ceramic fibers coated with an interphase of pyrocarbon and SiC consolidation.

4/ Heat treatment by self propagating high temperature synthesis: initiating at 1100° C. with heating at a rate of 200° C./min under 50 bar of dinitrogen. Pause at temperature for 30 min. Controlled cooling down to ambient temperature.

The aluminum reacts with the gaseous phase to form AlN in the pores of the fiber preform, with the following reaction:

2Al₍ₛ₎+N_{2(g)}→2AlN₍ₛ₎

Adding carbon powder serves advantageously to increase the nitriding yield of the aluminum by reacting with the protective layer of alumina on the particles of aluminum (chemical reduction).

### Example 7

### Forming a Matrix Comprising Phases of BN and of Ti—C—N

The sequence of the various steps of another example method of the invention is described below:

1/ If necessary, grinding the B₄C in isopropanol/ethanol.

2/ Mixing together the powders with a molar ratio Ti/B₄C=1.

3/ Putting the powders into suspension in ethanol and adding 2 mg/m² of PEI as steric dispersant. The quantity of dry matter in suspension lay in range 15% to 20% by volume.

4/ Impregnating by SPA (4 bar to vacuum) into a fiber structure made up of ceramic fibers coated with an interphase of pyrocarbon and SiC consolidation.

5/ Heat treatment by self propagating high temperature synthesis: initiating the reaction by an electrical filament, under 1000 bar of dinitrogen.

The powders react with the gaseous phase to form a matrix made up of BN and Ti—C—N in the pores of the fiber structure, with the following reaction:

xTi₍ₛ₎+B₄C₍ₛ₎+[(4+y)/2]N_{2(g)}→4BN₍ₛ₎+Tiₓ—C—N_{y(s)}

TiN is preferably formed during the combustion stage. Free carbon coming from the decomposition of B₄C diffuses in the TiN lattice to form a Ti—C—N phase.

### Example 8

### Forming a Matrix Comprising Phases of Al₂O₃ and SiC

The sequence of the various steps of another example method of the invention is described below:

1/ Grinding (SiO₂)a quartz in distilled water. The powders obtained present a median diameter lying in the range 0.5 μm to 1 μm.

2/ Mixing together SiO₂, commercial Al, and commercial C powders in respective proportions by weight of 56%, 33%, and 11%.

3/ Putting the powders into suspension in ethanol and adding 2 mg/m² of PEI as steric dispersant. The quantity of dry matter in suspension lay in range 15% to 20% by volume.

4/ Impregnating by SPA (4 bar to vacuum) into a fiber structure made up of ceramic fibers coated with an interphase of pyrocarbon and SiC consolidation.

5/ Heat treatment by self propagating high temperature synthesis: initiating the reaction by an electrical filament, under an inert atmosphere.

The powders react in the pores to form SiC and Al₂O₃, with the following reaction:

3SiO₂₍ₛ₎+4Al₍ₛ₎+3C₍ₛ₎→3SiC₍ₛ₎+2Al₂O₃₍ₛ₎

### Example 9

### Forming a Matrix Comprising a Phase of SiAlON Type

The sequence of the various steps of another example method of the invention is described below:

1/Grinding SiO₂ powder under water and Si powder under isopropanol/ethanol. The powders presented a median diameter lying in the range 0.5 μm to 1 μm.

2/ Mixing together the powders with the following composition by weight: 70% Si, 15% SiO₂, and 15% commercial Al. A small amount of Y₂O₃ was added (about 3% by weight) to further stabilise the resulting SiAlON in phase.

3/ Putting the powders into suspension in ethanol and adding 2 mg/m² of PEI as steric dispersant. The quantity of dry matter in suspension lay in range 15% to 20% by volume.

4/ Impregnating by SPA (4 bar to vacuum) into a fiber structure made up of ceramic fibers coated with an interphase of pyrocarbon and SiC consolidation.

5/ Heat treatment by self propagating high temperature synthesis: rise to 1400° C. at a rate of 200° C./min under 10 bar of dinitrogen. Pause at temperature for 30 min. Controlled cooling down to ambient temperature.

SiAlON is formed in the pores of the preform by the following reaction:

4.5Si₍ₛ₎+Al₍ₛ₎+0.5SiO₂₍ₛ₎+3.5N_{2(g)}→β-Si₅AlON₇₍ₛ₎

### Example 10

### Forming a Matrix Comprising a Phase of Si₂N₂O and an Environmental/Thermal Barrier

The sequence of the various steps of another example method of the invention is described below:

1/ Grinding powders of SiO₂, of mullite (3Al₂O₃.2SiO₂), and of Y₂Si₂O₇ under water, and of Si under isopropanol/ethanol. The powders presented a median diameter lying in the range 0.5 μm to 1 μm.

2/ First impregnating by SPA of a fiber structure with a first powder mixture, constituted by 58% by weight of Si and 42% by weight of SiO₂, previously put into aqueous suspension at pH 9, the suspension being filled at 20% by volume.

3/ Drying the material at 100° C. overnight.

4/ Second impregnation of the fiber structure by vacuum transfer of a second powder mixture constituted by 72% by weight of Y₂Si₂O₇ and by 28% by weight of mullite, previously put into aqueous suspension at pH 12, the suspension being filled at 25% by volume.

5/ Drying the material at 100° C. overnight.

6/ Heat treatment by self propagating high temperature synthesis: rise to 1450° C. at a rate of 200° C./min under 20 bar of dinitrogen. Pause at temperature for 30 min. Controlled cooling down to ambient temperature.

Si₂N₂O is formed in the pores of the fiber structure, and Al₂O₃, Y₂O₃, and SiO₂ are formed on the surface of the part, over a depth of a few tens of micrometers.

The term “comprising/containing a” should be understood as “comprising/containing at least one”.

The term “lying in the range . . . to . . . ” should be understood as including the limits.

1. A method of fabricating a part made of ceramic matrix composite material, the method comprising the following step:
a) fabricating the part by forming a ceramic matrix in the pores of a fiber structure, the ceramic matrix being formed by self propagating high temperature synthesis from a powder composition present in the pores of the fiber structure;
the matrix formed during step a) comprising a majority by weight:
of Si₂N₂O formed by self propagating high temperature synthesis by chemical reaction between a silicon powder, a silica powder, and a gaseous phase comprising the element N; or
of phases of TiN and of TiB₂, these compounds being formed by self propagating high temperature synthesis by chemical reaction between a powder comprising titanium, a powder comprising boron, and a gaseous phase comprising the element N.

2. A method according to claim 1, wherein, prior to step a), a preliminary step b) is performed of densifying the fiber structure by a method other than the method of self propagating high temperature synthesis.

3. A method according to claim 1, wherein an additional step c) of densifying the part is performed after step a).

4.-8. (canceled)

9. A method according to claim 1, wherein the following steps are performed before step a):
inserting at least a first powder into the pores of the fiber structure; and then
inserting at least a second powder different from the first into the pores of the fiber structure;
a ceramic matrix of composition that varies on going towards the outside surface of the part being obtained after step a).

10. A method according to claim 1, comprising a step of forming an environmental and/or thermal barrier, the environmental and/or thermal barrier being present after step a) over all or some of an outside surface of the part.

11.-12. (canceled)

13. A method according to claim 1, wherein the matrix formed during step a) comprises a majority by weight of Si₂N₂O formed by self propagating high temperature synthesis by chemical reaction between a silicon powder, a silica powder, and a gaseous phase comprising the element N, and wherein a powder comprising boron is present in the pores of the fiber structure prior to step a), and during step a) the powder comprising boron forms a BN phase by a nitriding reaction with the gaseous phase.

14. A part made of ceramic matrix composite material, the part comprising:
a reinforcing fiber structure; and
a ceramic matrix comprising a majority by weight of Si₂N₂O present in the pores of the fiber structure, the matrix presenting a content by weight of residual free silicon that is less than or equal to 5%.

15. (canceled)

16. A part according to claim 14, wherein the matrix comprises crystalline Si₂N₂O at a content by weight greater than or equal to 70%.

17. A turbine engine including a part according to claim 14.

18. A method of fabricating a part made of ceramic matrix composite material, the method comprising the following step:
a) fabricating the part by forming a ceramic matrix in the pores of a fiber structure, the ceramic matrix being formed by self propagating high temperature synthesis from a powder composition present in the pores of the fiber structure;
the matrix formed during step a) comprising a majority by weight:
of TiC and of SiC, these compounds being formed by self propagating high temperature synthesis by chemical reaction between a powder comprising titanium, a powder comprising silicon, and a powder comprising carbon; or
of AlN formed by self propagating high temperature synthesis by chemical reaction between a powder comprising aluminum, a carbon powder, and a gaseous phase comprising the element N.

19. A method according to claim 18, wherein, prior to step a), a preliminary step b) is performed of densifying the fiber structure by a method other than the method of self propagating high temperature synthesis.

20. A method according to claim 18, wherein an additional step c) of densifying the part is performed after step a).

21.-25. (canceled)

26. A method according to claim 18, wherein the following steps are performed before step a):
inserting at least a first powder into the pores of the fiber structure; and then
inserting at least a second powder different from the first into the pores of the fiber structure;
a ceramic matrix of composition that varies on going towards the outside surface of the part being obtained after step a).

27. A method according to claim 10, further comprising a step of forming an environmental and/or thermal barrier, the environmental and/or thermal barrier being present after step a) over all or some of an outside surface of the part.

28.-29. (canceled)

30. A method of fabricating a part made of ceramic matrix composite material, the method comprising the following step:
a) fabricating the part by forming a ceramic matrix in the pores of a fiber structure, the ceramic matrix being formed by self propagating high temperature synthesis from a powder composition present in the pores of the fiber structure;
the matrix formed during step a) comprising a majority by weight:
of phases of BN and of Ti—C—N, these compounds being formed by self propagating high temperature synthesis by chemical reaction between a powder comprising titanium, a powder comprising boron and carbon, and a gaseous phase comprising the element N; or
of phases of Al₂O₃ and of SiC, these compounds being formed by self propagating high temperature synthesis by chemical reaction between a powder comprising silicon and oxygen, a powder comprising aluminum, and a powder comprising carbon; or
of a SiAlON type compound formed by self propagating high temperature synthesis by chemical reaction between a silicon powder, a silica powder, a powder comprising aluminum, and a gaseous phase comprising the element N.

31. A method according to claim 30, wherein, prior to step a), a preliminary step b) is performed of densifying the fiber structure by a method other than the method of self propagating high temperature synthesis.

32. A method according to claim 30, wherein an additional step c) of densifying the part is performed after step a).

33.-37. (canceled)

38. A method according to claim 30, wherein the following steps are performed before step a):
inserting at least a first powder into the pores of the fiber structure; and then
inserting at least a second powder different from the first into the pores of the fiber structure;
a ceramic matrix of composition that varies on going towards the outside surface of the part being obtained after step a).

39. A method according to claim 30, further comprising a step of forming an environmental and/or thermal barrier, the environmental and/or thermal barrier being present after step a) over all or some of an outside surface of the part.

40.-41. (canceled)
